(19) United States
(12) Patent Application Publication
(10) Pub. No.: US 2021/0207394 A1
(43) Pub. Date: Jul. 8, 2021

(54) FOLDING CASE BE USED AS A CRIB TENT OR SMALL VESSEL

(71) Applicant: Paolo ELMI, Massa (IT)

(72) Inventor: Paolo ELMI, Massa (IT)

(21) Appl. No.: 16/066,544

(22) PCT Filed: Jan. 4, 2017
(86) PCT No.: PCT/IB2017/050023

§ 371 Date: Jun. 27, 2018

(30) Foreign Application Priority Data
Jan. 8, 2016 (IT) 102016000000975

(51) Int. Cl. E04H 15/40; E04H 15/04; A47D 9/00; A01K 1/02; A61G 1/013

(52) U.S. Cl. CPC E04H 15/40; E04H 15/04; B64D 17/00; A01K 1/0254; A61G 1/013; A47D 9/005

(57) ABSTRACT

Folding casing formed of intersecting arches or rings and stretched by inner traction elements.

### TECHNICAL FIELD

A flexible casing, collapsible and extensible that in unfolding and expanding phase can be made rigid and pull taut until an inner supporting plane is also tensioned to bear a body's weight and that can have different functions including: cradle, kennel for small pets, stretcher that can be capsule-like closed, kayak and other small watercrafts, tents and emergency collective multipurpose tents.

### BACKGROUND ART

Among the foldable and lightweight casings mainly used in camping, hiking and open-air, most of them, to fold them up, require being demounted, disassembling its parts in pieces and, to use them again, it is often needed to mount them again throughout long and complex operations. For tents, demountable canoe or others apparatuses it is needed to thread rigid or flexible poles into the poles sleeves sewn in the fabric and slide the pole all of the way through or using zip fasteners, clips or other joining systems. In all these cases the structure (frame and poles) does not cooperate, or at least to a very small extent, with the fabric planes that are just hung to these structure so that these structures have to be strong enough for the required effort.

Over the last few years, the so called “pop-up” opening system casings established themselves on the market. Most of them are small tents but also kennels and some cradle models hosting inside structures consisting of one or more flexible rings, already included in the same apparatus. The main advantage of these “open in 2 seconds” apparatuses, is a considerable saving in time, they just need to be unlocked, but on the other hand they result in very unstable and precarious casings, held in tension by just modest torsional and bending forces of the rods because the relative strength applied to the structure in unfolding phase, is released during the automatic re-opening movement. Moreover, in these pop-up structures there is no evidence of any synergy between the frame and the casing surfaces.

Nevertheless, there are covering systems mainly used in architecture but also for archaic tent such as the pole-mounted tents including the arabic ones, that can be defined “tensile-structure”. These are fabric surfaces put in tension between the vertexes of one or more poles and the ground where the apparatus is firmly staked down by placing pegs through some straps or grommets and pulling the straps away from the same structure to keep these coverings taut, to the detriment of mounting speed and lightweight.

No casings can be found on the market whose frame rods or poles are already firmly fixed to the casing surface to put it in tension and thus obtaining a braced structure and at the same time geometrically designed in a manner that allow an easy and fast opening as well as an easy and compact folding. Shell-like, spheroidal or hemispheric structures are also missing on the market, namely apparatuses where the supporting plane it is not just the ground or the bottom of the structure whilst usually it is necessary add other heavy foldable apparatuses like cots, mattresses or seats because they not use the same strength of the tensioned casing to support the load.

With regard to the cradles, similarities have been found with these others two patents:

GB2493546A

EP1061206A2

that in any case, do not realize all the goals set out in our patent. In the two above mentioned patents there are no relevant solutions that can form a shell made of fabric surfaces taut and rigid enough such as to pull an inner supporting plane stretched enough to be capable of bearing the weight of a body. Moreover, no existing solution allow to reduce the casing (cradle or other) to a circular bundle of few centimeter of diameter.

Regarding to the hammock tents having an inner horizontal support connected to the casing, the following patent must be highlighted:

Tent igloo Wo 2004/035968

Self supporting tent hammock Gb 2486665

both these patents address the problem of supporting an inner surface but they lack many elements that confer to the structure stability and flexibility such as: a joint to which the rods are hinged, tensioning elements, angles for bracing the surfaces, equilibredin a way to avoid the use of heavy and rigid frames or others.

In some apparatuses among the demountable (non-folding) kayaks available on the market, the fabric casing covers a frame previously mounted.

In some recent solutions for foldable canoes and kayaks the hull is formed by folding and then linking the two sides of a single pre-slit semi-rigid plastic sheet like an origami. These solutions are superlight and space-saving when folded up but folding and unfolding results in a quite complex, laborious and lengthy process.

### SUMMARY OF INVENTION

The present invention has the scope to create, for specific applications, an ultra-lightweight, easy foldability casing that can be stretched, in operating phase, when folded out, by tensile forces that pull apart all its elements that thus become equally tense or compressed creating a strong, sturdy, difficult to deform structure. In almost every application of this invention, inside the volume of these casings, it is firmly attached a lightweight supporting surface, stretched between the casing walls. This surface, when burdened with additional weights, does not reduce but it rather increases tension on all components of the structure.

In order to achieve these results, the subject-matter of this invention is an apparatus consisting in a fabric or other material external casing (1) plane and flexible, formed as a closed surface. In some applications of the invention it is an ovoid, cocoon or pea pod-like shaped whereas in some other applications is hemisphere, dome-like shaped. The said external casing stiffened by a coplanar reinforcement of arches or rings consisting in stays or flexible rods firmly attached to the casing surface. In these casings, the external surface is securely and tightly fixed to the rods that innervate it, such in the orthopaedic braces and sails. The mutual tensional force between the casing stays and surfaces structures, is realized by means of two antagonistic forces on one or both two elements of the structure.

In essence, in order to produce the tensioning of the casing it is necessary either reduce the casing's surface, causing rods to curve, or bending the rods as an arch, forcing the casing's surface to expand (such as when opening an umbrella). Therefore exerting to opposite senses, tensioning forces are released: either opening the casing edges or releasing tensioning elements that have bent the rods and thus, easing off the tensile forces, the solid can collapse in different ways such as the figure-eight shaped torsion of the rings like in the “pop-up” closing systems and the poles reverse torsion as in FIGS. 32, 33, 34.

Tensioning elements may then vary in nature, sometimes for instance are passive and serve as constraints when acting on different components of the structure, like in the case of the inner supporting surfaces (cradle, kayaks and the self-supporting hammock-tent), that antagonistically withstand and are stretched when the “stays-casing” system that contains them, is expanded and put under tension.

When folding out the cradles, FIG. 1, 3, 4 and the kennel, FIG. 8, tensioning is reached by energetically bringing the two contiguous casing sides closer (4); this also applies to the tensioning of the kayak (FIGS. 20 and 21), the emergency capsules (FIG. 16) and the floating shelter (FIG. 17). In the alternative solution for kayak on FIGS. 22 and 23, tensioning is reached through forced insertion of ribs inside the already closed casing (FIG. 61).

The structure of these solids may be formed by a group of ring stays (3,9) intersecting in two diametrically opposite one another positions (7) as in FIGS. 1, 2 and 8 or, in a second solution, may be formed by a group of arch or hemispheric rods (2, 28, 42, 57) just like all the other applications of the present invention. These arches connect their endings either to two joints (8), always in diametrical positions on the casing, or, in the case of dome-shaped casinos application, to just one joint (45, 58) and to the casing circumference fixed to the ground (48, 55) as in FIGS. 35,36,37,40,41 and 42.

An the applications of this invention have in common same static and dynamic principles: fabric casing and related rods reinforcement form a solid and taut structure only when:

the casing forms a closed surface;

the endings of the arches are connected one another through at least one traction element;

a traction element acts either arching the rods of the structure or reducing the same casing surface.

Action causing more rods to arch indeed, induces an increase of the casing surface that is consequently stretched. Conversely, in the applications where the tension occurs by means of tightening of the casing surfaces, the rods are bended due to the reduction of the same casing surface.

Subject matter of the present invention are therefore also casing apparatuses wherein, as for the hanging tent in FIGS. 30 and 31, the casing, already formed such as a closed casing, is tensioned but not by closing the shell surface whereas by bringing the poles closer by means of specific traction elements that bend the arches acting on this antagonist force and put in tension the whole shell.

In the second structural solution as in FIGS. 3 and 4, the rods or poles that structure the casing are hemispherical or arch-shaped hoops whose two ends converge hinging in two joints (8); this structure partially differs from the one previously described in that the partial reopening of the casing is performed by mere flexure or by spring-based systems that are specific and internal to the joint. This structure also, when folding out, shell be tensioned by joining two edges of the casing either by means of zip fasteners or other joining means or by specific edges for traction, hooked by means of hooking apparatuses (14) that can also serve as handles; in any case this tensioning action—through a rotational action of the arches and rings hinged to their poles such as meridians moving away from each other—creates a rigid shell composed of rigid surfaces and compressed arched rods acting as counterforce and fixed to the inside of these surfaces. This tensioning is possible since the arches and the hemispherical portions of the rings cannot open and unfold being constrained by traction elements located within the shell that, as just described, in the case of cradles, kayaks or floating shelters, consists of a fabric surface (5) connected to the joints or poles and to the casing as well around its perimeter wherein the casing acts antagonistically when the apparatus is tensioned by the force of the arches pushing to open. The casing, made of fabric or other flexible, plane and resistent to coplanar deformation materials, compresses the rods inwards and the rods expand and stretch the surfaces outwards. The result is that the rods, not being able to bend in any other direction, distinct from the one whereto they are firmly fixed (being constrained by the connection to the planes), are subject mainly to compressive forces along just their longitudinal axis.

The advantages of this inventive solution regard at least three elements:

the synergy between rods and fabric planes allows a remarkable economy of materials and thus of weight as well, with a good result in terms of robustness.

rods can be thinner and bend in small diameter rings;

these shell-shaped casings bear bumps and direct impacts, deforming elastically namely, in a non-fragile way ensuring a good level of content security from accidental collisions.

Moreover, the folding geometry allows ultra compact in size and lightweight solutions for these casings.

However, this innovation's peculiar characteristic is that, inside these casings there is a supporting plane, like a sheet, stretched over all sides, around the perimeter of the casing but not like a hammock, since the hammock is put in tension between just two extremes, so that to serve as bed or adjustable seat, making other heavy and bulky foldable apparatuses such as mats, seats or cots unnecessary to be added after having opened the casing. This supporting plane, capable of bearing serious loads, fully shifts the weight onto the casing rods and external cloths. This weight is equally distributed and shared among the all elements of the structure and collaborates, when supporting a load, on increasing the tension of the other elements of the structure.

### BRIEF DESCRIPTION OF DRAWINGS

FIG. 1 represents the pop-up and collapsible casing with function of cradle, in the three-hoops version.

FIG. 2 shows the longitudinal section of the above mentioned cradle.

FIG. 3 represents the casing with function of cradle, structured by six semicircular arches hinged in two joints located at the extremes of the casing's major axis.

FIG. 4 represents a casing with function of cradle alternative to the version of cradle described above in FIGS. 1-3, wherein rods are not semicircular but consist in more arches converging in two joints located on the major or longitudinal diameter of the casing surface.

FIG. 5 shows a possible solution of polar joint where three rings are intersecting, these being part of a casing with function of cradle which closes with torsional and flexional “pop-up” movements.

FIG. 6 shows a joint solution for cradle, composed of arches whose ends are connected two by two to it, with a spring element facilitating cradle unfolding and reopening.

FIG. 7 shows another type of joint capable of hinging arched rods of a casing with function of cradle. Joint consists of two shells, closed by a screw and its locknut, and contains the ends of the rods whose extremes end with small spheres that allow, in the collapse phase, to bundle all the rods together in parallel but with no spring back, as for the joint depicted in FIG. 5.

FIG. 8 represents a casing consisting of just two circle rods or hoops with function of “pop-up” collapsible pet carrier or kennel for small animals.

FIGS. 9,10,11,12,13 schematically represent three folding phases of the cradle depicted in FIG. 1 and of the kennel in FIG. 8, both designed with “pop-up” method of folding.

FIG. 14 represents a section of a casing having function of stretcher and closed “capsule-like rescue stretcher” which can be towable like for a snow slide and liftable with a hoist wire rope.

FIG. 15 represents an orthogonal section of the same casing depicted in FIG. 14.

FIG. 16 represents the capsule-like rescue stretcher in vertical lifting phase,

FIG. 17 represents a floating shelter for one or two people.

FIGS. 18,19 shows the above mentioned casing of FIG. 17 section view and seen from a different perspective.

FIG. 20 shows a longitudinal section of the casing version with function of kayak and emergency night shelter for hiking lovers.

FIG. 21 shows the casing with function of kayak lateral view.

FIG. 22 shows the casing with function of kayak top view.

FIG. 23 shows a lateral view of the casing with function of kayak for two persons.

FIG. 24 shows a cross mid-section of the casing with function of kayak.

FIG. 25 represents the kayak bow overview.

FIGS. 26,27,28,29 show the kayak collapse and bending sequence, similar to the other casings of the present invention.

FIGS. 30,31 represent a hanging casing with function of shelter or tent for the garden where the traction of the structure results from shortening the elements that connect the opposite poles.

FIGS. 32,33,34 show how to collapse and fold, for a space-saving storage, casings such as the ones shown in the above figures.

FIG. 35 represent a hammock-tent with function of both tent and hammock in a single body.

FIG. 36 shows the hammock-tent longitudinal section and FIG. 37 shows the hammock-tent top view highlighting the base-perimeter shape.

FIG. 38 Represents the folding of the tent depicted in FIGS. 35,36,37.

FIG. 39 shows the earth terminal of the rods that, thanks to a not brand-new solution, eases ground anchoring.

FIG. 40 shows the section of a shelter or tent that can also have big dimensions, tensioned by an inner braced dome, tied to the external dome by some wires.

FIG. 41 represents a dome tent similar to the one depicted in FIG. 40 where external bands or webbings contribute to consolidate the structure, serving as further traction elements.

FIG. 42 shows how to transform dome or hemispherical tents, like the ones depicted in FIGS. 40 e 41, into structures to be parachuted.

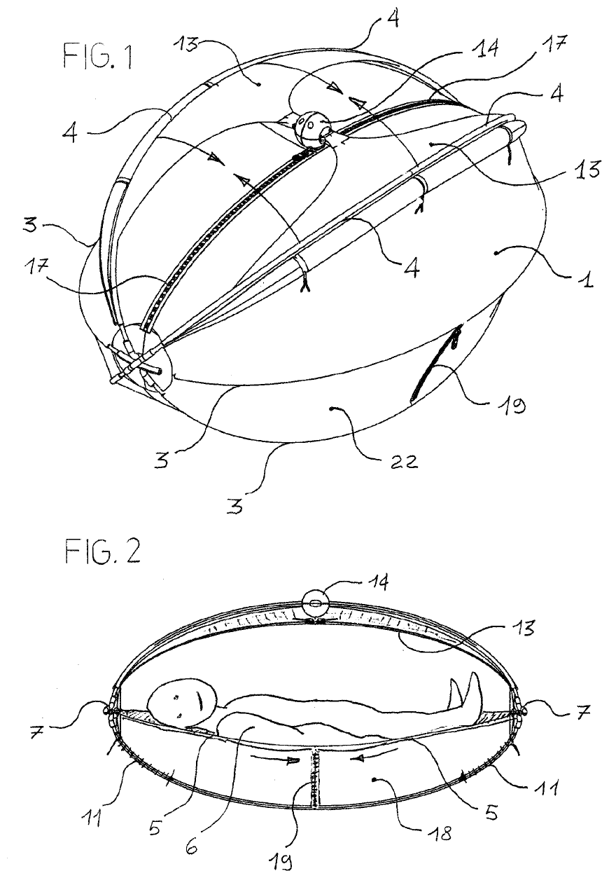

### EXAMPLES

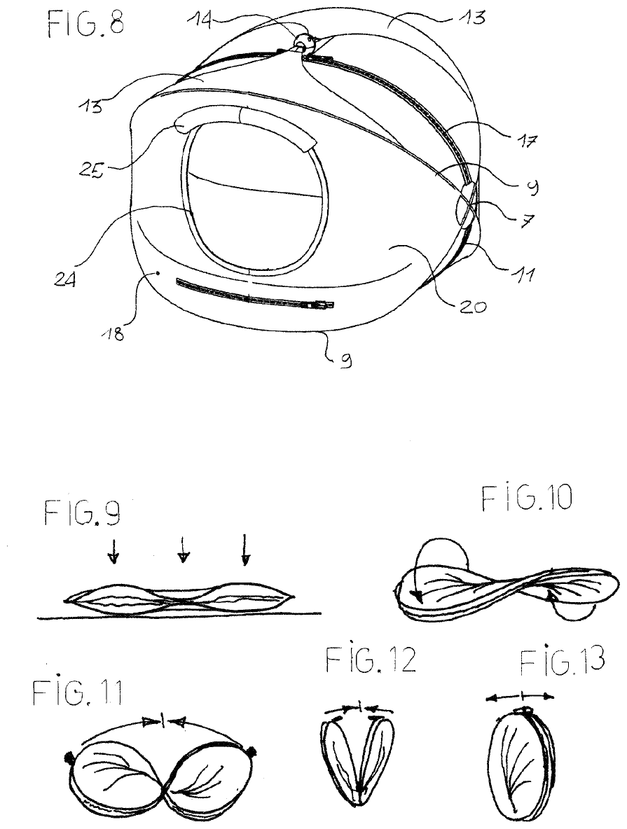

In solutions of casing with two or more rods (FIG. 8 depicting the one with two rods and FIG. 2 the one with more rods), these rods intersect on the casing surface in two polar joint (7) at the casing diameter edges. These casing can be folded thanks to a figure-eight shaped torsion typical of pop-up systems, see FIGS. 9,10,11,12 and 13, by just separating upper surface edges that keep the casing in tension so that the entire apparatus collapses and the rings, become coplanar, can thus be folded. In folding phase, it should be possible to dilate the lower sheet (10) in some portions of it, therefore it should be made of highly elastic material or deformable fabric or also, be partially opened by a zip fastener (11).

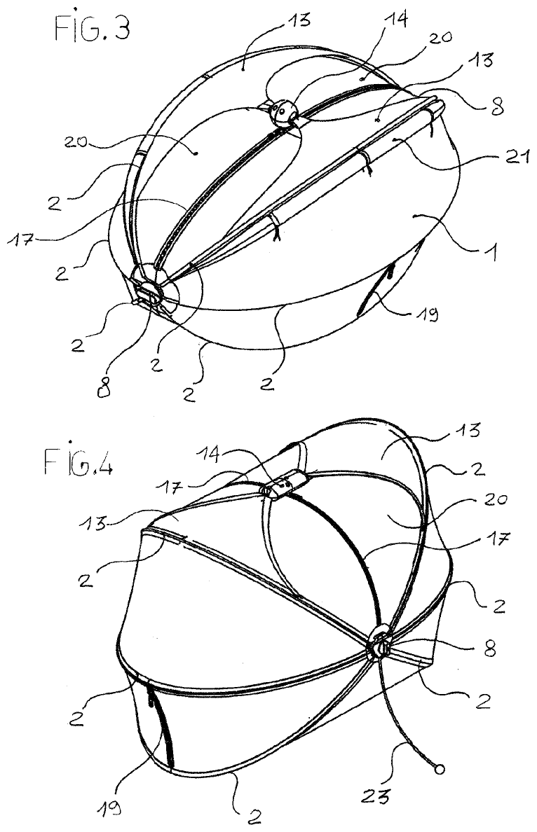

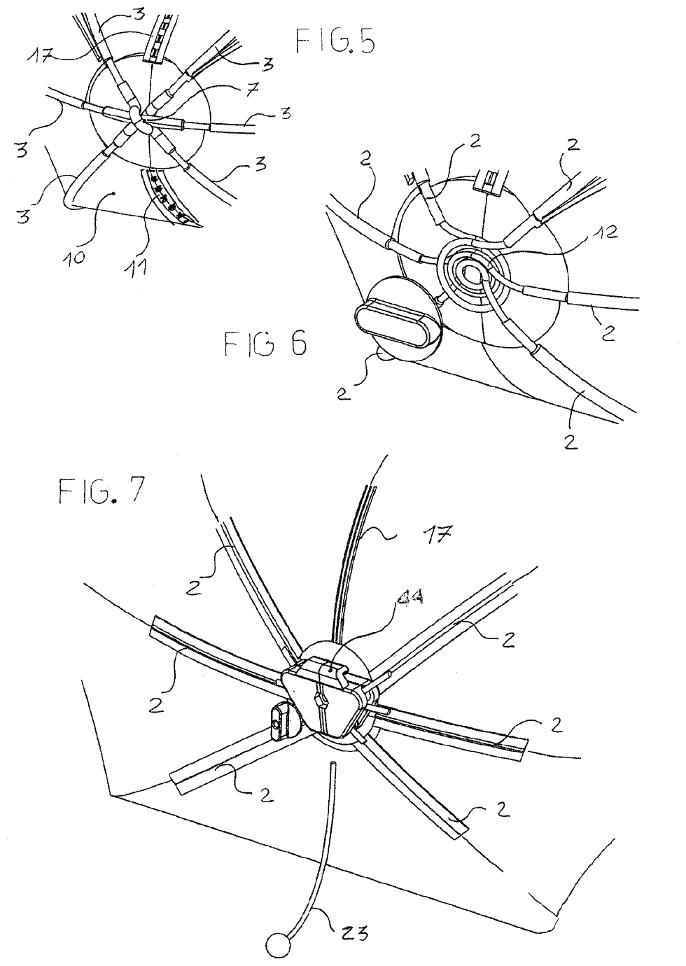

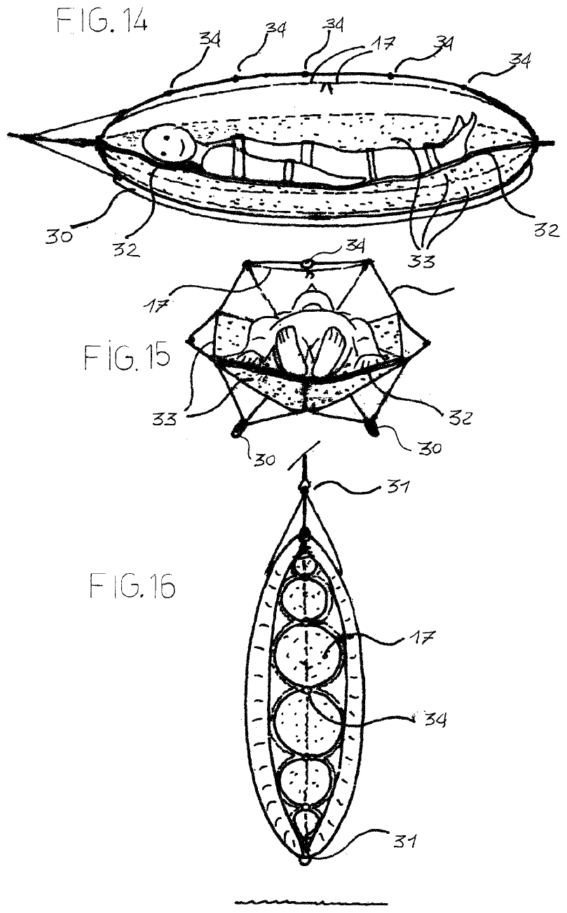

In the cradle alternative structure of FIGS. 3 and 4 and in the other applications (kayak in FIG. 20, “floating shelter” in FIG. 19 and “capsule shelter” FIG. 14), the casing is structured with semicircular rods (2) whose ends are hinged in two joints (8) located on the smaller diameter of the casing like in FIG. 4 or on the larger casing diameter.

In all these applications, when one wishes to bend the casing in order to collapse it, it is necessary to unhinge the upper tensioning edges (13) and the lower zip fastener (17) that closes the casing, then rotate all arches around the axis on which the two joints intersect. When all the arched rods are coplanar, it is possible to bring together the two joints in one point so to further reduce casing footprint, (see kayak folding sequence in FIGS. 26, 27, 28 and 29).

In all versions of the cradle, under the inner supporting surface (5) there is a serving compartment (18) that can be accessed from side openings (19) which can be closed with zip fastener that do not interfere with the surface tensioning since oriented in the same direction of tensile forces. This version of cradle, as well as other applications of the present invention, is provided with one or more loose mesh pieces of fabric for ventilation, baby visual control or serving as mosquito net. All applications are also provided with roll up blind windows and doors (21) to cover mosquito nets and openings (24, 50). Casing lower sides (22) in direct contact with the ground, are provided with plastic-coated waterproof material.

Versions of the cradle with arched rods articulated on the minor diametric axis as in FIG. 4, are provided with two adjustable stabilizing brackets (23) connecting to the two joints. Casing surface is equipped with loops, located correspondingly to the two joints, to connect any belt and webbing sling for easy carrying, hanging or linking the cradle to other supports.

The two-rings version of pet kennel for small animals as in FIG. 8 is designed with a single side opening (24). Casing is made of breathable but waterproof material whereas both inner supporting surface and parts of the lateral surfaces are made of abrasion- and scratch-resistant materials. Interspace under the cot surface comes in handy for storing a spare mattress. A roll up door (25) with zip fastener protects entry from rain and wind.

Casing with function of tent for one or two adult person has larger size and can fulfil its threefold functions of: tent that rests on the ground; hammock-tent tensioned and hung parallelly to the ground between two points by means of wires; hanging tent vertically hung.

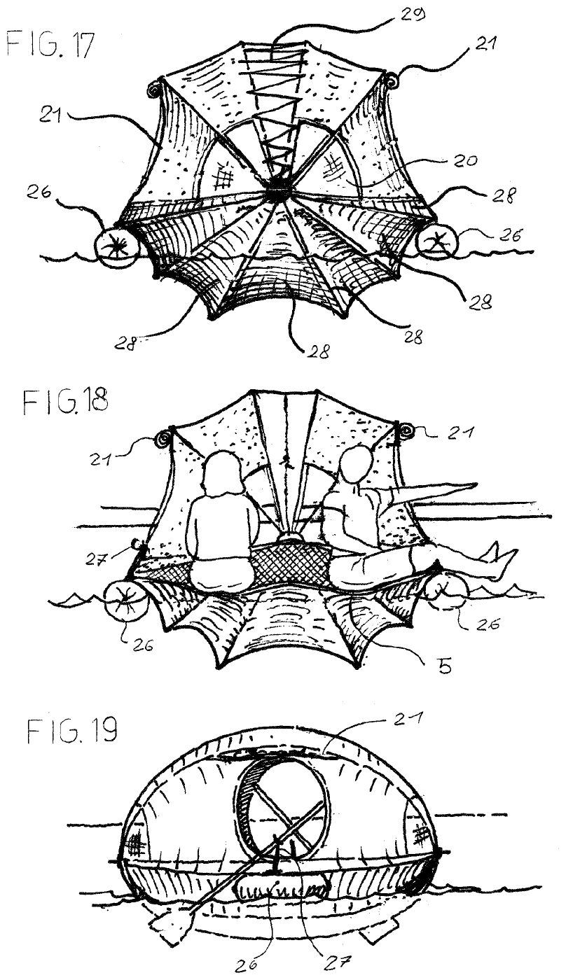

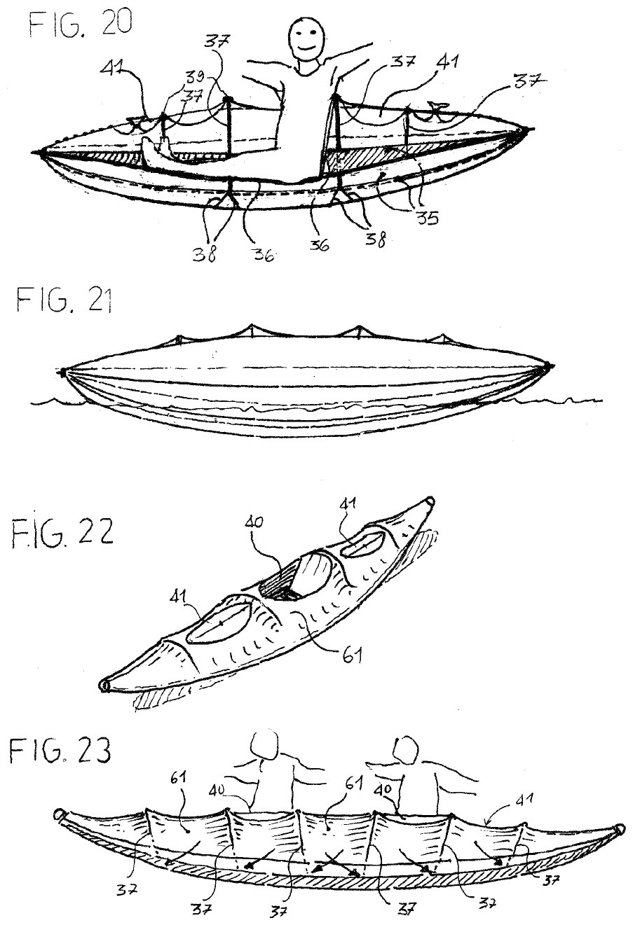

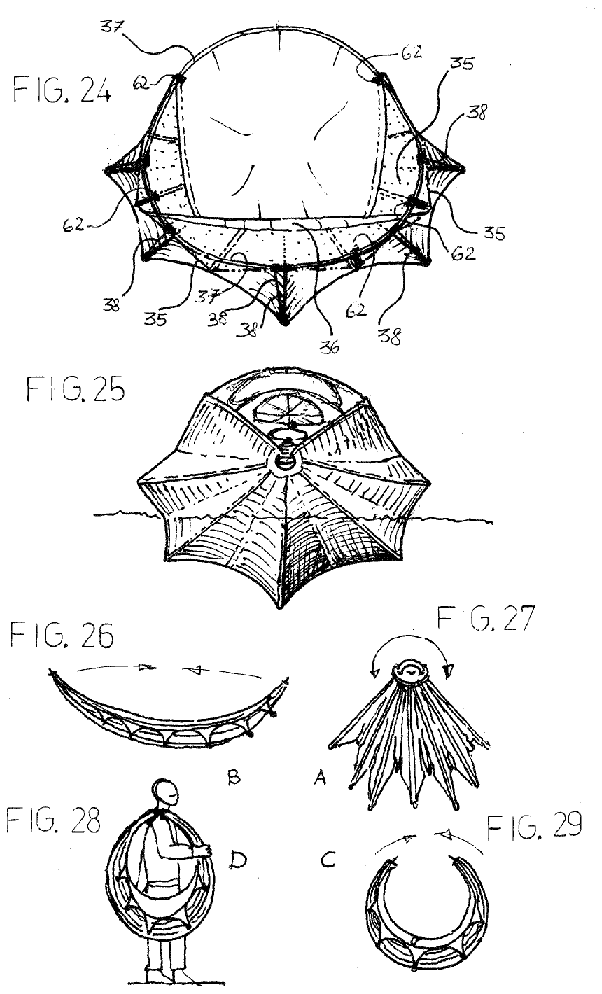

Floating shelter as in FIGS. 17, 18 and 19 with bottom and sides consisting of multilayer plastic-coated fabric sheets (28), is a vessel for leisure designed to float on lakes or swimming pools. Two floating stabilizers are placed on the two sides of the casing (26) and two removable rowlocks at each bottom of the two side entries where oars can be placed. Structure tensioning is obtained through reinforcing straps, sewn on the casing fabric (29).

Casing with function of capsule-like foldable stretcher as in FIGS. 14, 15 and 16, can be mounted on runners, connected to lower arched rods, for traveling or conveying people or loads over snow and ice. Placing a hook on its top (31), it can also be liftable by an helicopter connecting a wire rope to its traction hoist and thus used as stretcher in emergency situations even at sea. Besides the supporting plane sheet serving as a cot (32), there is another inner fabric plane that allows to further stiffen the structure longitudinally. Tensioning of the capsule is guaranteed by some interlocking pieces placed between the casing opened edges (34).

In the kayak casing, FIGS. 20, 21 22 23 24 and 25 as well as in the capsule-like stretcher, fabric planes are added to the supporting sheet for longitudinal bracing (35). In the kayak casing there are also two or more transverse bracing rods with function of ribs (37) removable and connected to the longitudinal rods with specific small feet (38) or lever latches (62) since the long profile of the floating shelter makes longitudinal rods, that are just very little arched, easy to laterally collapse. Kayak and capsule as well, are folded and tied shut with strings and specific hooks located on the edges (39) or, when the casing is already closed (61), it can be closed by just inserting the circular ribs and bending them till the tensioning of the casing and therefore tying off and binding them inside the casing through specific straps or lever latches (62). Hatches (40) are further innervated by fabric backseats and seats. Special small holds are also designed with exterior access (41). This kayak collapses to become a long bundle of parallel rods and can be easily folded up in a circle by just linking the two element joints placed at their ends and carried on a shoulder.

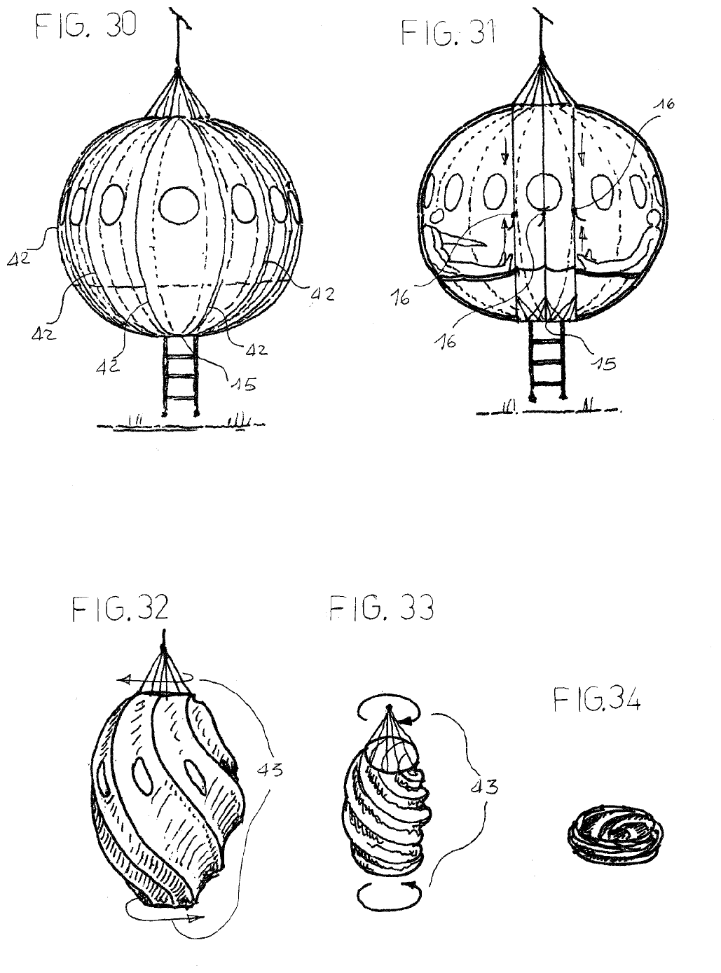

A further application of the present invention (a hanging spherical tent) as in FIGS. 30 and 31 is characterized by traction obtained not throughout joining the external edges of the fabric but by tensioning belts tensioned between the two poles. In such casing folding is possible by loosening and releasing said straps and twisting (43) in opposite direction the two little polar rings of the casing, where rods are vertically hinged (42), around its longitudinal axis till this tent is reduced to the dimension of a small cylinder as in FIGS. 32, 33 and 34.

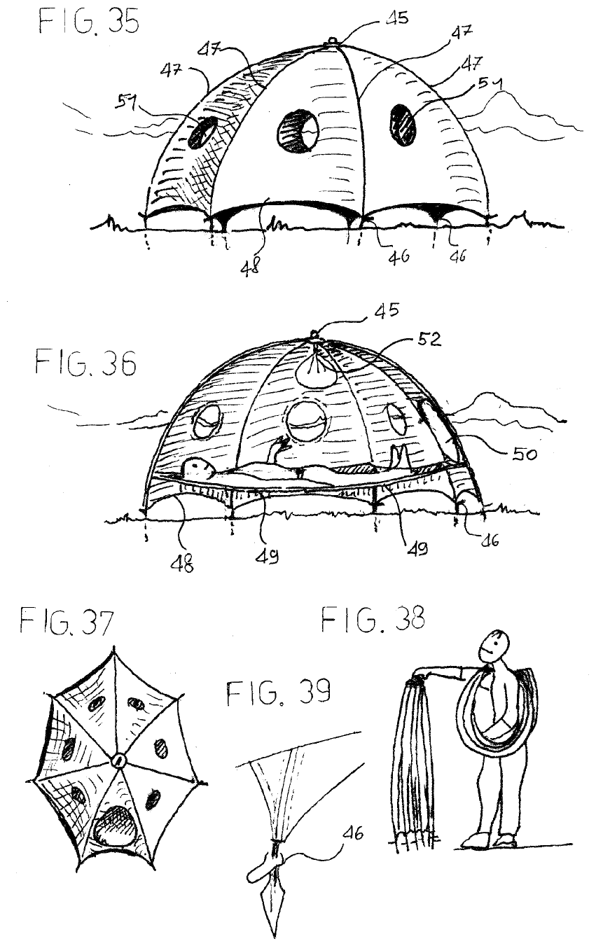

The self-supporting tent represented in FIGS. 35, 36, 37 and 38 is also subject to the same tensional principle of the other casings but rods are connected to just one upper joint and not two so that instead of joining to another joint, these rods, branching off the casing, are driven and stocked into the ground with its peg feet (46). Internally and at the bottom of this casing is horizontally located a supporting plane (49) able to bear an adult person as in the picture. Level between this plane and the casing is designed in a way that the back of the person when lies down does not reach the level of the undelying ground. Portholes (51), inner supports (58), protection sheets and other typical accessories for tents are also parts of the equipment.

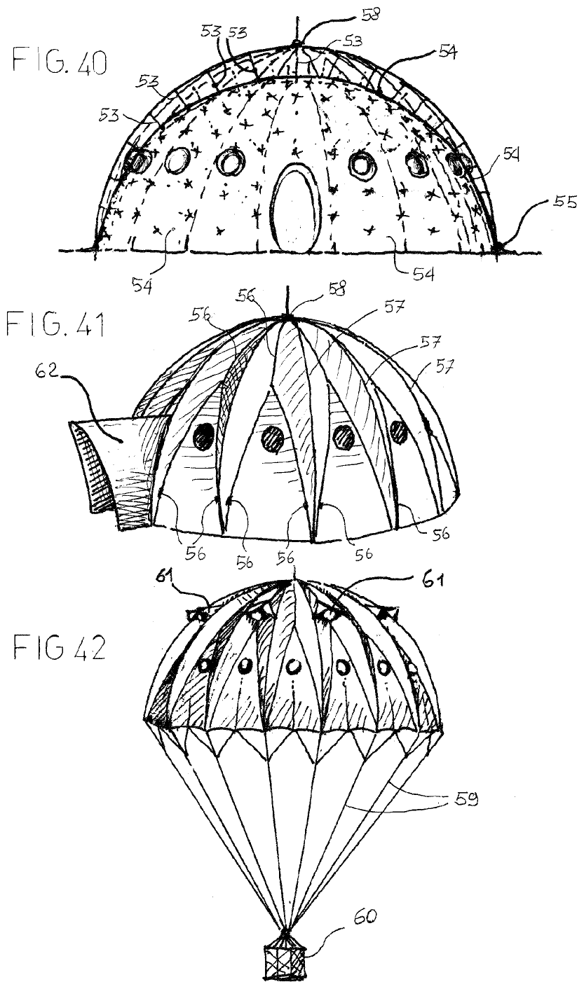

FIG. 40 represents the section of a casing with function of shelter or tent tha can also be designed in bigger dimensions, provided with an upper joint (58) hinging the rods wherein inner tensional elements consist of an inner dome for bracing, tensioned with straps (54) against the external dome of the casing. This specific surface arches the rods of the external dome and thus performs the same function of the inner surfaces of other applications of the present invention.

Casing depicted in FIG. 41 represents a dome tent similar to the previous one where belts or webbings (56) can be added as further elements of traction that are connected to the external casing surfaces and can be tensioned after the casing bottom has been ground-anchored.

Big tents just above described are designed to address humanitarian emergency or army and can be supplemented by suitable fabric tunnels (62) to link tents together in camps. These tens are also able to turn into parachutable structures as in FIG. 42 even proper parachutes capable of bearing, a part its own little weight, during the lowering of the load, proportionate shipments. The bottom of the casing can equipped indeed with suspension lines like the parachute's ones (59) whereto shipments are hooked to a paylock for air shipping cargo delivery (60). specific openings (61) usefull for ventilation when tent is on the ground, while airdropping namely in descending phase serve as stabilisers.

The present invention, until now described with reference to preferred embodiments, should not be considered as restricted to that described above and shown on the drawings, many modifications being conceivable without departing from the spirit and scope of the appended claims.

### CITATION LIST

Citation List follows:

IT102016000000975

GB2493546A

EP1061206A2

WO2004/035968

GB2486665

1. A folding shell-shaped casing composed of textile surfaces or other flexible surfaces, the textile surfaces or other flexible surfaces being structured with bent rods shaped like arches or rings,
wherein:
the textile surfaces or other flexible surfaces of the folding shell-shaped casing are firmly constrained to said bent rods along their entire extension;
the bent rods in the folding shell-shaped casing expansion phase bend and stretch along with the surfaces of the folding shell-shaped casing whereto they are connected creating non-coplanar arches having converging ends hinged in two joints, or creating rings which equally intersect in two poles, set in a diametrically opposed position on the surface of said folding shell-shaped casing;
the poles or joints being connected among them through one or more inner traction elements whose length regulates the distance among said poles or joints or the bending radius of the bent rods; and
a horizontal inner surface being connected to said casing around the perimeter;
in an operating phase the tensioning of the folding shell-shaped casing and its collapse occur joining or separating two adjacent edges of the outer surface, through connection elements and/or acting on one of said inner means of traction.

2. A folding casing shaped like a dome or hemisphere composed of textile surfaces or other flexible surfaces, the textile surfaces or other flexible surfaces being structured with arch-shaped bent rods,
wherein:
the surfaces the folding casing are firmly constrained by said arch-shaped bent rods along their entire extension;
the arch-shaped bent rods in an expansion phase bend or stretch along with the surfaces of the folding casing in accordance with its spherical-cap geometry and form non-coplanar arches having one of their ends convergent and hinged in an upper joint;
the arch-shaped bent rods radially branching off from the joint whereto they are hinged reach the base circumference of the dome wherein the free end comes out of the surface of said folding casing and ends with an element which firmly connects it to the ground; and
traction elements connected among them and/or to the joint and or to the base circumference of the dome regulate the bending radius of the arch-shaped bent rods.

3. The folding casing of claim 1 wherein the traction elements can be comprised of:
webbings, ropes, cables, belts or other surfaces directly connecting the two poles or joints; and
webbings, ropes, cables, belts or other surfaces connecting the upper joint to the base circumference of the dome;
the connection among them or to the surfaces of the folding casing of said traction elements constrains and/or vary the opening radius of said arches or rods rings.

4. The folding shell-shaped casing of claim 1 wherein the rods which reinforce it are composed of two or more non-coplanar rings; said rods in the unfolding phase intersect in at least two diametrically opposed points; in the folding phase, disjointing some edges of the surfaces of the casing, this can collapse and the rings of rods can be placed one on the top of the other, forming among them a parallel bundle which can be folded further on.

5. The folding shell-shaped casing of claim 1 wherein the rods which reinforce it are in the shape of arches and the ends of these join in two joints diametrically set along the surface of the casing; the ends of these connect to these joints through specific hinges so that in the casing folding phase, after having disjointed the edges of some surfaces and having opened the hinge all the arches can rotate on the hinges until assuming a coplanar shape, being than refolded again by bringing near and joining the two joints with a specific system of mutual hooking forming a ring bundle.

6. The folding casing of claim 1, serving as a transportable cradle for kids, comprising one or more of the following elements:
two or more edges of textile surfaces being linked on one side to the casing and on one of their ends to a hook in order to complete the tensioning of the structure;
parts of the casing being made of breathable material or textile working as a mosquito net;
parts of the surface of said casing being made of waterproof or impermeable material;
blackout textile connected or non-connected to the casing surface;
rings, buckles or other hooking systems connected to the outside of the casing in order to link webbings, belts or handles;
one or more compartments located lower than the inner support surface; and
possible stabilizing supports so as to avoid any swinging or overturning of the cradle.

7. The folding casing of claim 1 serving as a pet kennel or carrier for small animals which comprises:
a side entry;
handles for the transportation;
a removable and washable inner surface;
breathable surfaces or ventilation mosquito-nets;
possible stabilizing supports;
strong and impermeable lower surfaces; and
rainproof cloths and closure cloths of the side entry.

8. The folding casing of claim 1 serving as a tent or a shelter for one or more people which comprises one or more of the following elements:
One or more side entries:
upper and side hooking systems being said casing constrained by an upper support and/or side supports namely a hammock;
impermeable outer surfaces and breathable or thermal insulating outer surface portions; and
further removable outer protection cloths.

9. The folding casing of claim 1 serving as a floating shelter for still waters comprising one or more of the following elements:
lower surfaces made of impermeable, hydraulic pressure resistant materials namely rubber-coated cloths;
specific hooking oarlocks at the side entries and the support inner surface made out of loose mesh net; and
floating stabilizers placed on the sides of the casing.

10. The folding casing of claim 1 serving as a stretcher or a capsule-like stretcher in order to transport people comprising one or more of the following equipment:
water-repellent outer surfaces;
outer surfaces provided with significant thermal protection made of insulating or reflecting material;
ski connected to the rods oriented towards the ground being set in order to slide on snow and ice;
hooks for lifting hoist wire ropes from helicopters and related lashing; and
extra autonomy systems namely battery, photovoltaic surfaces, heating element, radio communicators, light emitters, oxygen suppliers.

11. The folding casing of claim 1 serving as a kayak and/or an emergency shelter provided with inner single or double small bed wherein the joints are placed at the ends of the longitudinal axis; in between being placed inside the casing rings or arches of removable rods, perpendicular to the longitudinal rods serving as supporting ribs; the backrest and the seat of the kayak are composed of tensioning cloth surfaces as well; a further surface internally connected to the outer casing, which in tensioning phase of the outer casing is tensioned before it, increasing the bending of the surfaces of the hull between one rod and another.

12. The folding casing of claim 11 wherein said supporting ribs insert themselves into a close casing in a perpendicular position to the longitudinal rods and fix to the casing by means of specific laces or hooks.

13. The folding casing as per of claim 1 with a spheroidal shape serving as hanging tent; supported by a hooking system in upper polar position; with access through an entry placed in lower polar position; all being put in traction and reinforced through a group of tightening belts through specific tie down ratchets which connect the upper pole to the lower pole; the casing comprising an horizontal inner supporting surface connected to the surfaces around the perimeter and centrally to the above-mentioned group of belts; the casing being able to collapse after the release of said traction elements twisting the casing around the axis which joins its poles.

14. The folding casing of claim 2 serving as a tent and an hammock as well provided with a flat and flexible inner supporting surface connected to the side surfaces of the casing; and provided with one or more side entries; transparent portholes or provided with mosquito-net; protection and blackout cloths which can be removed and hooks connected to the inside of the hinge knot in order to support extra materials; attached-to-the-ground ends of the rods which can be stuck into the ground provided with small aid levers.

15. The folding casing of claim 2 serving as a tent or shelter wherein a traction element producing the tensioning of the casing is composed of a surface in the shape of a dome having a bigger radius than the outer casing and connected to the lower strip of the dome around the perimeter but put in traction by means of specific tie-rods arranged all over the vault of the surface and connected via the other end on the inner side of the casing surface.

16. The folding casing of claim 2 wherein traction elements namely belts or straps are arranged on the outer surfaces of the casing in the room which divides the rods, run from the upper knot downwards pulling the casing surfaces towards the lower edge of the base circumference of the dome; said edge being already anchored in the ground in the opening phase.

17. The folding casing of claim 2 whose edge of the base circumference can be connected as in a parachute to tie-rods which support a weight at the other end; provided with portholes openable in the upper portion of the casing and measured so as to stabilize the falling of the tent when used as a parachute.
